(19) United States
(12) Patent Application Publication
(10) Pub. No.: US 2009/0068548 A1
(43) Pub. Date: Mar. 12, 2009

(54) Lithium Ion Prismatic Cells

(75) Inventor: Alexander Kaplan, Providence, RI (US)

Correspondence Address: FISH & RICHARDSON P.C., P.O. BOX 1022, MINNEAPOLIS, MN, 55440-1022, US

(73) Assignee: Gillettte Company, The, Boston, MA (US)

(21) Appl. No.: 11/850,971

(22) Filed: Sep. 6, 2007

(51) Int. Cl. H01M 2/02; H01M 2/12

(52) U.S. Cl. 429/56; 429/163

(57) ABSTRACT

The disclosure relates to prismatic lithium ion secondary cells. Some cells include venting features and/or multiple connecting tabs. In some cells the cathode includes LiFePO₄.

### TECHNICAL FIELD

This invention relates to secondary lithium batteries, and in particular to lithium ion prismatic cells.

### BACKGROUND

Rechargeable batteries, also known as secondary batteries, contain active materials that are regenerated by charging. When the energy produced by these batteries drops below optimum efficiency, they may be recharged in any one of many manners, depending upon their construction. Rechargeable batteries are broken down into two main classifications based upon the chemical composition of the battery. Both of these classifications, alkaline secondary and lithium secondary, contain a wide assortment of battery styles.

In contrast to secondary cells, primary electrochemical cells are meant to be discharged, e.g., to exhaustion, only once, and then discarded. Primary cells are not intended to be recharged. Primary cells are described, for example, in David Linden, Handbook of Batteries (McGraw-Hill, 2d ed. 1995).

Secondary electrochemical cells can be recharged many times, e.g., more than fifty times, more than a hundred times, or more. In some cases, secondary cells can include relatively robust separators, such as those having many layers and/or that are relatively thick. Secondary cells can also be designed to accommodate changes, such as swelling, that can occur in the cells. Secondary cells are described, e.g., in Falk & Salkind, “Alkaline Storage Batteries”, John Wiley & Sons, Inc. 1969; U.S. Pat. No. 345,124; and French Patent No. 164,681, all hereby incorporated by reference.

Digital cameras and other electronic devices (for example, cell phones, MP3 players, and personal digital assistants (PDA's) such as BlackBerries®) operate on batteries, such as secondary nickel metal hydride batteries or secondary lithium ion batteries. One type of battery that has been used in digital cameras is a 3.7 V secondary, prismatic lithium ion. Such batteries are commercially available, for example from Panasonic under the tradename Pentax D-L12. Batteries referred to as “prismatic cells” generally have a thickness that is much less than their width and length. For example, the Pentax D-L12 battery has a length of about 53.0 mm, a width of about 35.2 mm, and a thickness of about 7.0 mm. Many prismatic cells have dimensions in the ranges of 40-60 mm long by 30-40 mm wide by 4-10 mm thick.

### SUMMARY

In general, the invention features lithium ion secondary batteries in the form of prismatic cells. The cells include a housing having a prismatic shape, and, disposed within the housing, an anode, a cathode including lithium as an active component, a separator and an electrolyte.

In one aspect, the invention features prismatic cell type Li-ion secondary batteries in which the cathode contains LiFePO₄. Thus, in one aspect, the invention features a secondary battery comprising a prismatic-shaped housing that houses an anode, a cathode including LiFePO₄, and a separator between the anode and the cathode. These batteries have desirable properties for use in digital cameras and other applications.

In some cases, the batteries described herein are fast-charge capable rechargeable cells that can provide more than 100 cycles, typically many hundreds or thousands of cycles, before they need to be replaced. Some preferred batteries have a capacity of greater than about 5 mAh.

The cells also have a charge capability of 15 minutes or less, preferably 5 minutes or less. In addition, preferred cells made using LiFePO₄ cathodes generally exhibit good safety, fast charging (e.g., 5 minutes or less), good power density, consistent performance, and environmental acceptability. The fast charge capability of 5 minutes or less minimizes user inconvenience. Preferred batteries also provide excellent cycle life (e.g., greater than 1000 cycles and preferably greater than 1500 cycles to 80% of initial capacity at 0.5 A/0.5 A rates) and shelf life (3 years).

In another aspect, the invention features a lithium ion prismatic cell comprising cell components, including an anode, a cathode comprising lithium, and a separator between the anode and cathode, and a housing in which the cell components are disposed. The housing includes a plurality of vents, at least two of the vents being configured to burst when the internal pressure of the prismatic cell reaches different predetermined levels.

Some implementations include one or more of the following features. At least one of the vents may be in a side surface of the housing. At least one of the vents may be a coined feature. At least one of the vents may be an elongated groove having a triangular or trapezoidal cross-section. In one preferred implementation, one of the vents comprises an elongated groove. The elongated groove may have a length of about 0.05 to 0.70 inch, a depth of about 0.006 to 0.008 inch, and a width of about 0.004 to 0.006 inch. The elongated groove may have a length that is about 50 to 80% of the width of the cell, a depth such that the wall thickness in the groove is about 20 to 30% of the wall thickness of the housing, and a width that is about 50 to 60% of the wall thickness of the housing. The elongated groove may be close to an upper edge of the cell, e.g., the elongated groove may extend parallel to the top surface of the cell, on a side wall of the cell, at a distance of about 20 to 40% of the total height of the cell from the top edge of the housing.

The invention also features methods of making a prismatic cell that include deforming an area of the cell housing to form an elongated groove having a triangular or trapezoidal cross-section. Deformation of the housing may be accomplished by coining or electrochemical machining.

In a further aspect, the invention features a lithium ion prismatic cell comprising a housing having at least one substantially flat side running along the length of said housing the housing defining a negative contact and a positive contact, within the housing, an anode, and a cathode comprising lithium, wherein at least the cathode is in the form of a sheet having a predetermined length, and, a plurality of connection tabs disposed at spaced locations along the length of the cathode to connect the cathode to the positive contact.

Some implementations include one or more of the following features. The cathode may include a sheet form metal substrate, for example aluminum foil, and a coating of active material disposed on the substrate. The connection tabs may be disposed along an upper edge of the cathode. The connection tabs may be evenly spaced along the length of the cathode. The cell may comprise two, three or more connection tabs. The connection tabs may be formed of aluminum. The cathode may comprise a single sheet with multiple tabs, or multiple sheets, each sheet having at least one tab. The connection tabs may be integral with the substrate, or may be welded to the substrate.

For the purposes of this application, a “prismatic cell” has at least four generally flat sides, and has one dimension (e.g., thickness) that is substantially smaller than two other dimensions (e.g., length and width). As an example, a prismatic cell can have a thickness of between about 2 mm and about 15 mm (e.g., between about 4 mm and about 10 mm), a width of between about 10 mm and about 50 mm (e.g., between about 20 mm and about 40 mm), and a length of between about 20 mm and about 60 mm (e.g., between about 30 mm and about 40 mm). The length, width and thickness are measured as indicated by L, W and T, respectively, in FIG. 1B.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a perspective view of a battery taken from the front; FIG. 1A is a perspective view of the same battery taken from the back, showing a vent in the side wall of the battery; FIG. 1B is a further perspective view of the cell indicating how the dimensions of the cell are measured.

FIG. 2 is a top view of the battery of FIG. 1.

FIG. 3 is a cross-sectional view of the cell of the battery of FIG. 1.

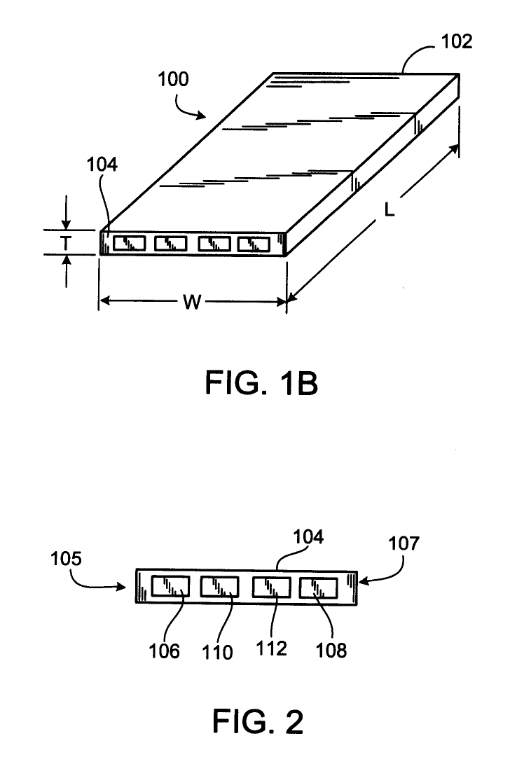

FIG. 4 is a highly diagrammatic top view of a prismatic cell with the cover removed to show multiple connection tabs at the top of the cell.

FIG. 5 is a cross-sectional view of the prismatic cell of FIG. 4.

FIG. 6 is an exploded view of the battery shown in FIG. 1.

FIG. 7 is an exploded view of the cell header of the battery shown in FIG. 1, and

FIG. 7A is an assembled view of the cell header.

FIGS. 8A-8E are highly diagrammatic views of alternate vent geometries.

FIGS. 9 and 10 are graphs showing voltage as a function of capacity and of charge time, respectively, for a prismatic cell having a construction as described herein, including a cathode having LiFePO₄ as its active material.

FIG. 11 is a graph showing charge voltage for a cell with a single cathode tab as compared to a cell having the same chemistry and construction but including two cathode tabs.

### DETAILED DESCRIPTION

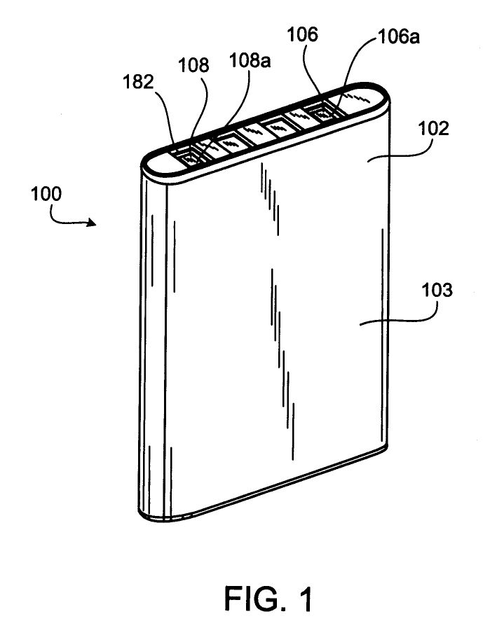

Referring to FIGS. 1 and 1A, a secondary lithium battery 100 includes a housing 102 housing 102 includes a front side wall 103 and a rear side wall 105, each of the side walls defining a broad flat surface.

As shown in FIG. 1B the housing 102 also has an upper surface 104. Upper surface 104 includes two ends, 105 and 107, that define the width W of battery 100. Battery 100 is a prismatic cell, and thus housing 102 also has a length L that is greater than its width W, and a thickness T that is substantially smaller than its length and width, as discussed above. Housing 102 can be made of a metal or metal alloy (e.g., nickel, nickel plated steel, stainless steel, aluminum, an alloy containing aluminum) or a plastic (e.g., a polyamide, polyvinyl chloride, polypropylene, polysulfone, acrylonitrile butadiene styrene (ABS), polystyrene). For instance, housing 102 is made of a stainless steel.

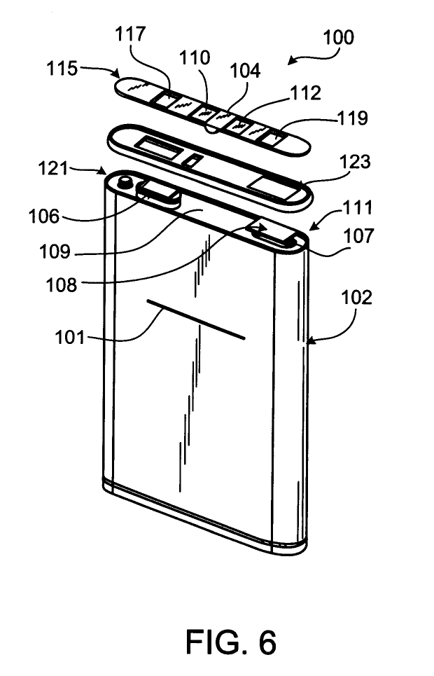

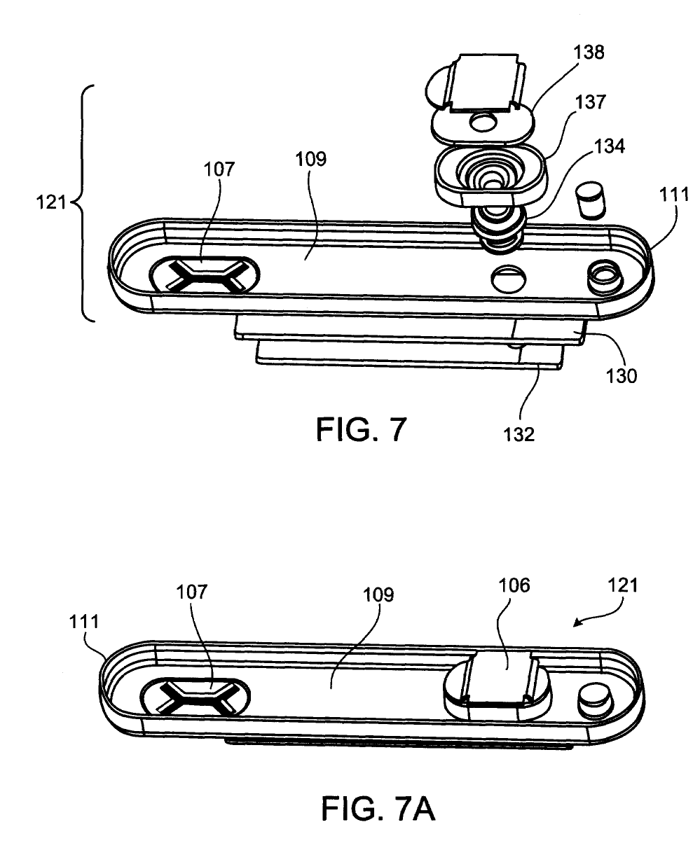

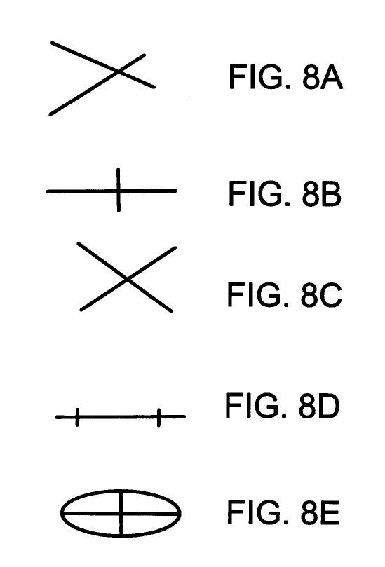

A cell header 121 is joined, e.g., by laser welding, to the top edge of the housing 102. The structure of cell header 121, shown in FIGS. 7 and 7A, will be discussed below. As shown in FIG. 6, a plastic top 123 and plastic cover 115 are mounted on top of the cell header to define an interface between the cell and the device in which the cell is utilized.

Referring to FIG. 1A, the battery 100 includes an elongated vent 101. Vent 101 is a groove having a reduced wall thickness, which provides an area where the metal of housing 102 will preferentially rupture when the internal pressure of the cell increases beyond a predetermined upper limit. Vent 101 may be formed by coining the groove into side wall 105 during manufacture of the can. Alternatively, vent 101 may be formed by electrochemical machining, or other suitable techniques for forming a groove having a reduced wall thickness. In some preferred implementations, the groove has a triangular or trapezoidal cross-section. The wall thickness in the vent area will depend on the desired burst pressure. As an example, if the predetermined burst pressure is 70 to 80 psi, the wall thickness at the thinnest point is generally from about 20 to 30% of the wall thickness of the housing outside of the groove. Providing vent 101 on the side wall 105 allows internal pressure to be relieved before significant dimensional distortion of the cell occurs. In preferred implementations, the vent 101 is configured to burst at a predetermined pressure that will minimize dimensional distortion such that the change in thickness T will be less than 1 mm.

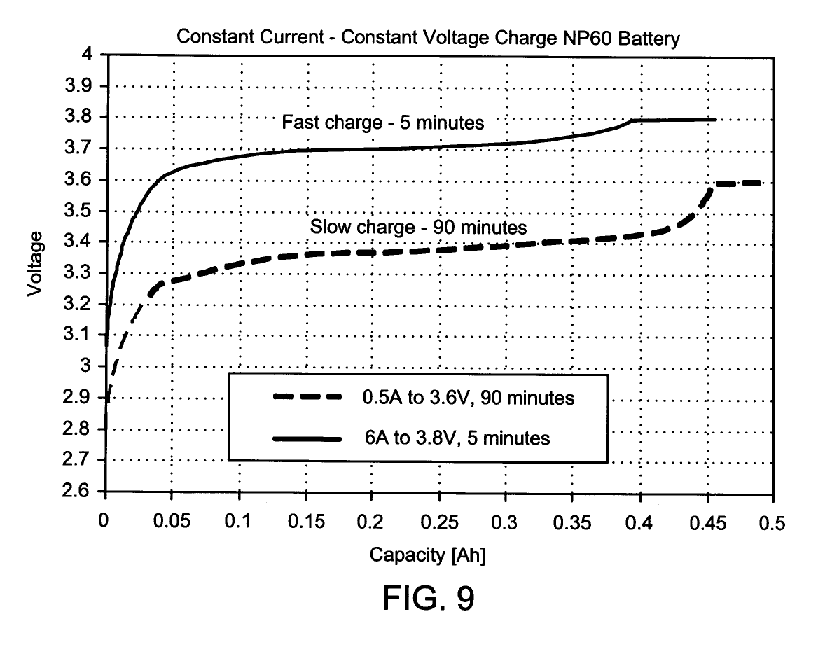

Referring to FIGS. 6-7A, the battery 100 also includes a secondary vent 107 in the upper surface 109 of the cover 111 of header 121. Secondary vent 107 is configured to burst at a different pressure than vent 101. For example, vent 107 may be configured to burst at a pressure of 150 to 160 psi. Secondary vent 107 is designed to burst when, despite the venting provided by vent 101, the internal pressure of the battery continues to rise. This continued rise in internal pressure, which may be due to overheating or other abusive conditions, produces a potentially dangerous condition due to the potential for explosion of the cell. Secondary vent 107 is a thin-walled area of the upper surface 104, the wall thickness of which is selected to burst at high pressure but before a dangerous condition is reached. Like vent 101, described above, vent 107 may be formed by coining or electrochemical machining. Vent 107 may have a “dog bone” shape, as shown in FIGS. 6-7A, or may have any desired shape that includes at least one intersection of two lines, to form a notch-sensitive location from which a crack can propagate. Examples of other suitable shapes are shown in FIGS. 8A-8E, and include x-shapes, crosses, multiple crosses, and a “cross-hair” shape such as that shown in FIG. 8E. Generally, this vent is small relative to the overall length of the header 121, and due to its small size and its position on the header it will tend to rupture at a higher pressure than the vent 101. The vent 107 ruptures at higher pressure not only because the notched area is generally smaller than vent 101, but also because of its location on the cover. Metal in the vent areas usually fractures via a ductile fracture mode, i.e., the fracture is characterized by tearing of the metal and significant plastic deformation. During internal pressurization of the prismatic package the side walls of the housing are more sensitive to pressure and experience higher levels of displacement and plastic deformation than the top cover or bottom of the housing. Because of the larger plastic deformation the side vent opens at lower pressure than the top vent. In some implementations, the wall thickness of the vent 107 in the cover is about 0.02-0.03 mm. The wall thickness of the vent 107 will typically be about 6-10% of the wall thickness of the cover.

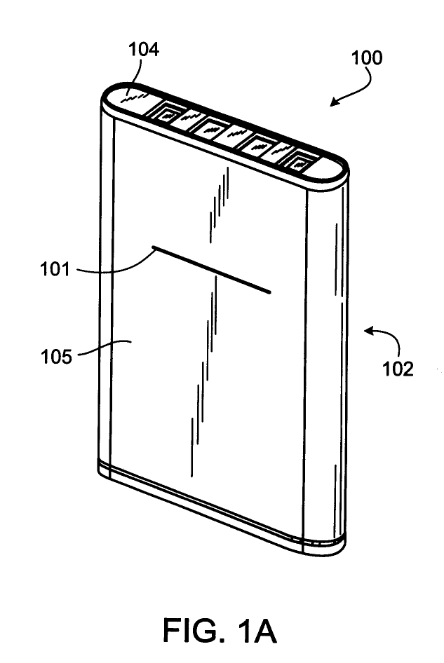

Referring now to FIGS. 2 and 6, surface 104 of battery 100 includes two electrical contacts: a positive contact 106 and a negative contact 108. As shown in FIG. 6, these contacts are positioned on the cell header 121 and exposed for contact through openings 117 and 119 in a plastic cover 115 which defines the surface 104. Between electrical contacts 106 and 108 are two recesses, 110 and 112, which are also defined by the plastic cover 115. Positive contact 106 is located approximately at end 105 of surface 104, while negative contact 108 is located approximately at end 107 of surface 104. Generally, recesses 110 and 112 are made of non-conducting materials. Recesses 110 and 112 can be made of, for example, a plastic (e.g., a polyamide, polyvinyl chloride, polypropylene, polysulfone, acrylonitrile butadiene styrene (ABS), polystyrene). In some cases, recesses 110 and 112 are made of the same material as housing 102, while in other cases recesses 110 and 112 and housing 102 are made of different materials.

The negative contact 108 and positive contact 106 may be of nickel or copper. The terms “nickel” and “copper” as used herein is intended to extend to alloys of these metals wherein nickel or copper comprises at least a substantial proportion thereof.

If the exposed contact surface of terminals 108 and 106 is of nickel, the electrical resistance between such terminal contacts and corresponding terminals of some digital cameras can be sufficiently high as to interfere with proper performance of the camera. For example, the elevated contact resistance may interfere with obtaining the required pulsed power necessary to operate the cameras in the most effective manner. Accordingly, in some implementations the exposed surfaces of the nickel contact 108 and 106 are plated with a layer of gold 108a and 106b respectively, as described in U.S. 2005/0158621, the full disclosure of which is incorporated by reference herein.

Although nickel is the preferred substrate for terminals 108 and 106 other substrates 108b and 106b, for example, copper or silver, may be used.

The cell header, shown in FIGS. 7 and 7A, includes a cover 111, an internal contact 132, to which the cathode is connected, and an insulator layer 130 disposed between the internal contact 132 and the cover 111. The cell header also includes a rivet 134 to hold the internal contact, insulator and cover together, and an external contact assembly including a seal 137, washer 138 and the external positive contact 106. Preferably, the washer is formed of a material that is weld compatible with the material of the positive contact 106, for example nickel plated steel or nickel if the positive contact is formed of a nickel-based material, to allow the positive contact 106 to be easily welded to the washer. Similarly, it is generally preferred that the rivet be formed of a material that is weld-compatible with the material of which the internal contact is formed, for example both may be formed of aluminum.

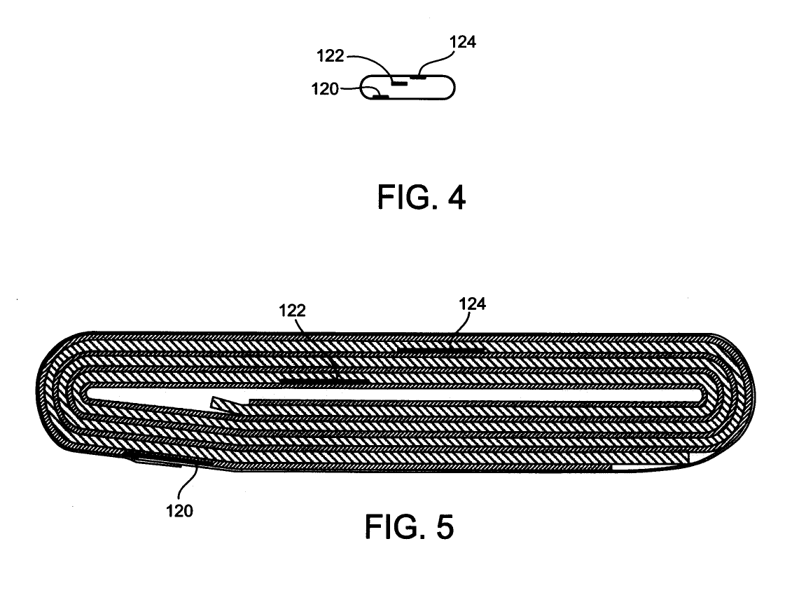

The battery uses a wound electrode design with interspaced cathode and anodes to increase the surface area, as shown in FIG. 5. In this case, the cathode 154 is wound together with the anode 150, with a separator 158 sprayed on or laminated in between the anode and cathode. In the implementation shown in FIG. 5, the electrodes are wound such that the winding has 10 to 15 layers. The electrodes and separator may also be folded or laminated together.

In some preferred batteries, the cathode 154 includes LiFePO₄ as its active material. The cathode may also include a binder. The thickness of the cathode will depend upon the cell configuration and performance characteristics.

The anode is generally a carbon anode. Other suitable anode materials may include alloy-based anodes (e.g., Li metal alloyed with Al, Si or Sn), lithium titanate (Li₄Ti₅O₁₂) with carbon, and various metal oxides.

The battery will also include an electrolyte 162, as is well known in the battery art. In the cells described herein, the electrolyte is generally not consumed during charge and discharge. Accordingly, the amount of electrolyte is determined by the porous volume available in the electrodes and separator.

Each electrode (cathode and anode) can be fabricated by providing a substrate and coating the substrate on both sides with the appropriate material, for example carbon for the anode and a mixture of binder, conductive carbon and active material for the cathode. Preferably, for the cathode the coating on each side is from about 30 to 45 microns thick, so that the total cathode thickness, prior to winding or folding, is about 70 to 90 microns. For the anode, it is preferred that the coating on each side be about 15 to 20 microns thick, so that the total anode thickness, prior to folding, is about 45 to 55 microns. The substrate for the cathode may be, for example, aluminum foil, and may have a thickness of from about 8 to about 35 microns. The substrate for the anode may be, for example, copper foil, and may have a thickness of from about 4 to about 35 microns.

The separator 158 may be sprayed onto either one or both of the electrodes for ease of assembly, or may be a separate component that is disposed between the cathode and anode.

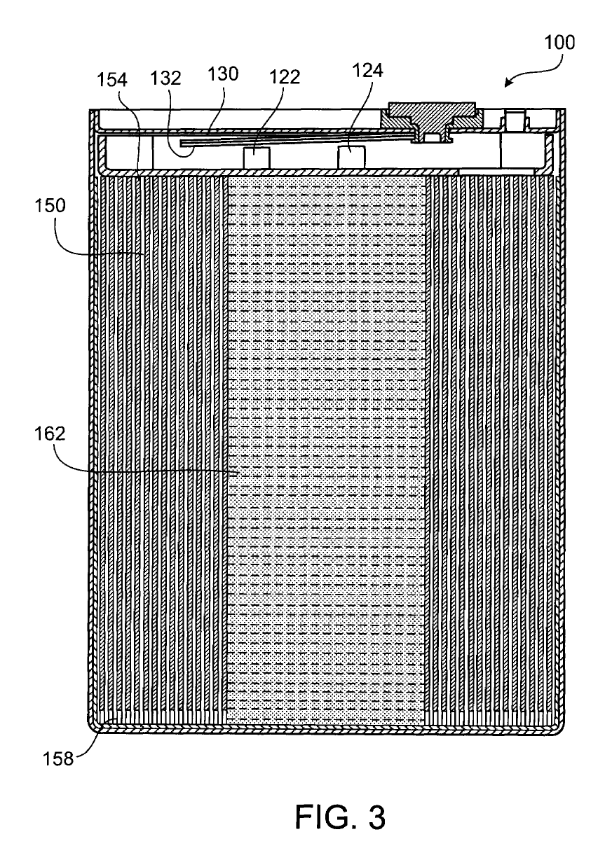

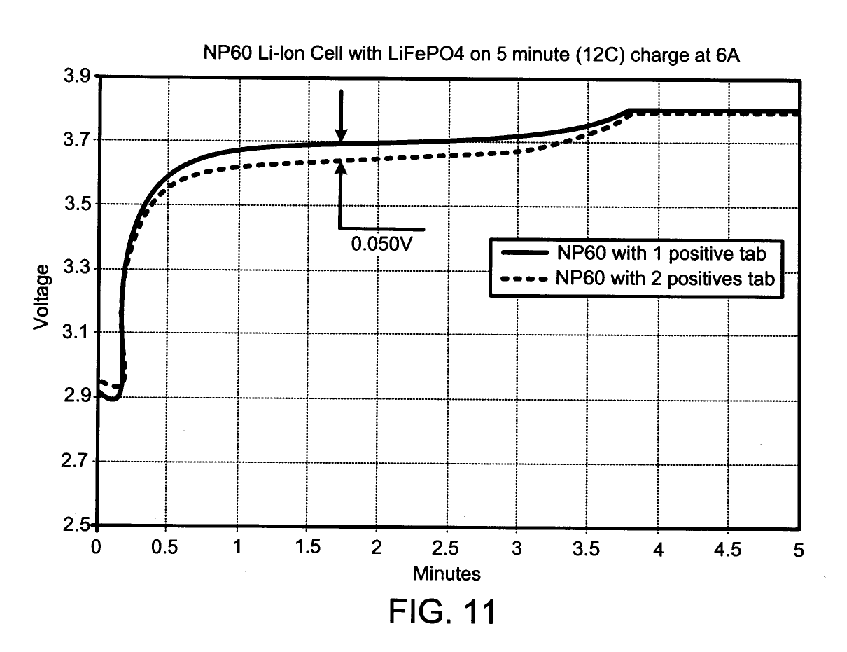

Referring now to FIGS. 4 and 5, connecting tabs are provided to connect the cathode and anode to contacts 106 and 108, described above. In the implementation shown in FIGS. 4 and 5, the battery includes a single anode tab 120 and two cathode tabs 122, 124. The cathode and anode tabs may be formed, for example, from aluminum. If desired, the cell may include more than two cathode tabs, for example three, four or even more. Utilizing multiple cathode tabs provides a current collection network, producing a substantially uniform current distribution over the length of the cathode. Multiple cathode tabs also tend to reduce local current density. As a result, voltage drop and resistive heating are reduced, reducing the internal resistance of the battery. For example, the internal resistance of the battery may be reduced by about 25 to 30% when two cathode tabs are used rather than a single cathode tab. This reduction is illustrated by the data shown in FIG. 11, which is a graph depicting a five minute charge of two lithium ion prismatic cells, one with a single cathode connecting tab and the other with two cathode tabs. The single tab was attached to the leading edge of the cathode, while in the two tab construction one tab was connected at the leading edge and the other was connected at the lengthwise midpoint of the cathode. The running voltage of the cell having two cathode tabs was 0.05V lower than the running voltage of the single tab cell, making it easier to achieve a five minute charge time with the two tab construction.

Generally, it is preferable to evenly space the cathode tabs along the length of the cathode. However, other spacings may be used to facilitate manufacturing.

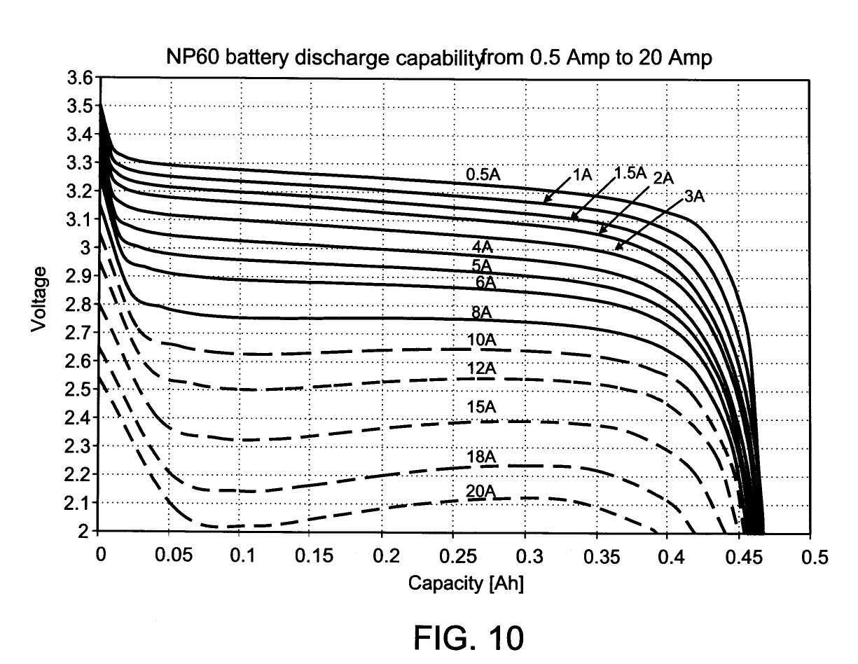

The cells described herein exhibit good performance characteristics, for example as illustrated in FIGS. 9 and 10. FIG. 9 is a graph of prismatic cell voltage and capacity during fast charge in 5 minutes and slow charge in 90 minutes. The graph shows that in some implementations the prismatic batteries described herein can be charged to 0.45 Ah in 5 minutes to a 3.8V cut-off, and conventionally in 90 minutes to 0.475 Ah to 3.6V by a constant current-constant voltage method. Thus, the cell can be charged to ˜95% of the rated capacity in just 5 minutes. FIG. 10 is a graph of prismatic cell voltage and capacity at various discharge rates. The graph shows that in some implementations the prismatic cell has a high discharge rate capability up to 40 C (C=0.5 A) and can sustain high level of loads up to 20 A.

A number of embodiments of the invention have been described. Nevertheless, it will be understood that various modifications may be made without departing from the spirit and scope of the invention.

For example, the venting arrangement and/or the multiple connecting tabs described above may be utilized with other cell chemistries. Other lithium ion chemistries may be used, for example lithium cobalt oxide or lithium nickel oxide. If these chemistries are used it may be necessary to add a thermistor or other device or electronics for charge control, as is well known in the art.

Accordingly, other embodiments are within the scope of the following claims.

What is claimed is:

1. A secondary battery comprising
a prismatic-shaped housing; and
an anode, a cathode including LiFePO₄, and a separator between the anode and the cathode disposed within the housing.

2. A lithium ion prismatic cell comprising
cell components, including an anode, a cathode comprising lithium, and a separator between the anode and cathode, and
a housing in which the cell components are disposed, the housing including two or more vents, at least two of the vents configured to burst when the internal pressure of the prismatic cell reaches different predetermined levels of internal pressure.

3. The cell of claim 2 wherein one of the vents is on a side surface of the housing.

4. The cell of claim 2 wherein at least one of the vents comprises a coined feature.

5. The cell of claim 2 wherein at least one of the vents comprises an elongated groove having a triangular or trapezoidal cross-section.

6. The cell of claim 2 wherein one of the vents comprises an elongated groove having a length that is about 50 to 80% of the width of the housing, a depth such that the wall thickness in the groove is about 20 to 30% of the wall thickness of the housing, and a width that is about 50 to 60% of the wall thickness of the housing.

7. The cell of claim 5 wherein the elongated groove extends parallel to a top surface of the cell, on a side wall of the housing, at a distance of about 20 to 40% of the total height of the cell from the top edge of the housing.

8. The cell of claim 3 wherein the cell further comprises a cover, sealingly joined to the housing, and the other vent is in the cover.

9. The cell of claim 8 wherein the wall thickness of the vent in the cover is about 6-10% of the wall thickness of the cover.

10. The cell of claim 8 wherein the vent in the cover has a shape that includes at least two intersecting lines.

11. The cell of claim 2 wherein said cathode comprises LiFePO₄.

12. A secondary lithium ion battery comprising:
a housing having at least one substantially flat side along the length of the housing, with the housing supporting a negative contact and a positive contact,
an anode, and a cathode comprising lithium, disposed within the housing, with at least the cathode comprising a sheet having a predetermined length, and
a plurality of connection tabs disposed at spaced locations along the length of the cathode to connect the cathode to the positive contact.

13. The battery of claim 12 wherein the cathode comprises a sheet form metal substrate, and a coating of active material disposed on the substrate.

14. The battery of claim 13 wherein the sheet form metal substrate comprises a copper foil.

15. The battery of claim 12 wherein the connection tabs are evenly spaced along the length of the cathode.

16. The battery of claim 12 wherein the connection tabs are formed of aluminum.

17. The battery of claim 12 wherein said cathode comprises LiFePO₄.

18. The battery of claim 12 wherein said anode and said cathode each include a foil layer and a coating of active material disposed on a surface of the foil layer.

19. The battery of claim 12 wherein said anode and cathode are each in the form of sheets, the sheets are spirally wound together, and the battery further comprises a separator interposed between the spirally wound sheets.

20. The battery of claim 12 wherein said housing has a thickness of between about 2 mm and 15 mm, a width between about 10 mm and 50 mm, and a length between about 20 mm and 60 mm.
